(19) United States
(12) Patent Application Publication
(10) Pub. No.: US 2006/0112131 A1
(43) Pub. Date: May 25, 2006

(54) Story rewriting system

(75) Inventors: Donald R. Harrold, Blair, NE (US); Andy Skinner, Spokane, WA (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(73) Assignee: STRIKE FRIDAY, INC., Shreveport, LA (US)

(21) Appl. No.: 11/181,680

(22) Filed: Jul. 14, 2005

Related U.S. Application Data
(60) Provisional application No. 60/587,927, filed on Jul. 14, 2004.

(51) Int. Cl. G06F 17/00; G06F 7/00

(52) U.S. Cl. 707/102

(57) ABSTRACT

A method of generating multiple related stories for an internet web site or web sites is disclosed. The method provides a computer having a display screen, a mouse, and internet access. Unique permutations of a story can be generated based on an input text that is displayed on the display screen. The computer can be provided with a thesaurus for locating synonyms for terms of the input text to be replaced. The thesaurus can be used to populate a check list with synonyms for a selected term of the input text. Some or all of the synonyms can be selected to populate an individual replacement database of chosen replacement terms. The input text can be rewritten in various permutations by substituting one or more terms from the personal database for a selected term of the story. Rewriting includes using the computer to supply one or more synonyms as a substitute word for the selected word.

### CROSS-REFERENCE TO RELATED APPLICATIONS

Priority of U.S. Provisional Patent Application Ser. No. 60/587,927, filed 14 Jul. 2004, incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to automatic content generation systems. More particularly, the present invention relates to an improved automatic content generation system that generates content from one or more user databases populated with replacement items/terms selected by a user for replacement.

2. General Background of the Invention

Content generation is an important part of services related to the internet. When a user searches the internet using a search engine, a product will appear more attractive to a consumer that is considering purchasing the product if the content that describes the product is unique.

Patents have issued that relate to this general subject matter. Each patent is hereby incorporated herein by reference:

TABLE 1
PRIOR ART PATENTS

| PATENT | |
|---|---|
| NUMBER | TITLE |
| 6,697,821 | Content Development Management System and Method |
| 6,694,482 | System and Methods for an Architectural Framework for |
| | Design of an Adaptive, Personalized, Interactive Content |
| | Delivery System |
| 6,665,870 | Narrative Electronic Program Guide with Hyper-Links |
| 6,596,031 | News Story Markup Language and System and Process for |
| | Editing and Processing Documents |
| 6,492,998 | Contents-Based Video Story Browsing System |
| 6,392,664 | Method and System for Presenting Television Programming |
| | and Interactive Entertainment |
| 6,266,094 | Method and Apparatus for the Aggregation and Selective |
| | Retrieval of Television Closed Caption Word Content |
| | Originating from Multiple Geographic Locations |
| 6,243,740 | Public Interactive Document |
| 6,230,173 | Method for Creating Structured Documents in a Publishing |
| | System |
| 6,199,082 | Method for Delivering Separate Design and Content in a |
| | Multimedia Publishing System |
| 6,038,573 | News Story Markup Language and System and Process for |
| | Editing and Processing Documents |
| 5,937,418 | Automatic Wire Copy Data Feed Distribution System |
| 5,907,837 | Information Retrieval System in an On-line Network |
| | Including Separate Content and Layout of Published Titles |
| 5,841,741 | Automatic Seamless Branching Story-Telling Apparatus |
| 5,713,743 | Storytelling Flip Over Picture Book and Method of |
| | Providing and Presenting a Story |
| 5,181,162 | Document Management and Production System |

Automating content generation from a source content document allows for development of new unique content for personal use at a website or for ad copy. A user could sell this generated unique content to others for their use at websites, or for ad copy. Writers could be offered a tool to enhance their writing in generating new unique content based on one or more source documents. There is a need to provide a method and apparatus in the form of an automated content generation.

While certain novel features of this invention shown and described below are pointed out in the annexed claims, the invention is not intended to be limited to the details specified, since a person of ordinary skill in the relevant art will understand that various omissions, modifications, substitutions and changes in the forms and details of the device illustrated and in its operation may be made without departing in any way from the spirit of the present invention. No feature of the invention is critical or essential unless it is expressly stated as being “critical” or “essential.”

### SUMMARY OF THE INVENTION

One embodiment includes a method and apparatus for generating multiple related stories which can be used for various purposes (e.g., for content generation on one or more internet web sites). In one embodiment a computer can be provided having a display screen, a mouse, and internet access, the display screen accepting one or more sets of input text. In one embodiment one or more output texts can be generated based on a single input text displayed on the display screen.

In one embodiment the computer can be provided with a population of database builders, each database builder having a set of replacement items/terms indexed to a name/title/identifier for the respective database builder. In one embodiment, various items/terms of an input text can be used to access one or more database builders from the entire population of database builders.

In one embodiment various database builders can be used to ultimately generate one or more specific individual replacement databases indexed to one or more items/terms of the input text. In one embodiment, the population of database builders can be searched by name/title/identifier and/or by items/terms contained in each database builder. Some or all of the replacement items/terms in an individual database builder can be selected by a user to populate a specific individual replacement database for a specific item/term of the input text. Alternatively, one or more specific replacement databases can be independently created for one or more items/terms of the input text.

In one embodiment individual replacement identifiers are provided with a name/title/identifier. In one embodiment, the population of replacement databases can be searched by name/title/identifier and/or by items/terms contained in each replacement database.

From this process a set of specific individual replacement databases can be created for an input text, each individual replacement database having one or more items/terms which can be used for replacement. From this set of specific individual replacement databases, various permutations of the original input text can be generated wherein items from the individual replacement databases can be randomly selected for each of the respective input text items/terms thereby rewriting the input text into new iterations of output text.

For example, a database builder can be provided with “click” boxes that enable a user to “click” on (i.e., select) one or more possible replacement items or terms with a computer mouse, for example when selecting a replacement synonym or when building an individual replacement database for a specific term of an input text.

In one embodiment the computer can be provided with a thesaurus for including possible additional choices of replacement items/terms to be included in one or more database builders in the population of database builders. In one embodiment, a new database builder can be generated from possible replacement items/terms found in the thesaurus. In one embodiment the thesaurus can be used to add to a specific individual replacement database containing zero or more replacement items/terms (such as a list of synonyms) for any selected term of the input text.

In one embodiment one or more replacement items/terms can be entered by a user directly into a specific database builder. One or more terms can also be deleted. Additionally, one or more specific database builders can be deleted from the population of database builders.

In one embodiment one or more replacement items/terms can be entered directly by a user into a specific individual replacement database. One or more terms can also be deleted. Additionally, one or more specific replacement databases can be deleted from the population of replacement databases.

In one embodiment one or more items/terms can be entered directly by a user into a thesaurus database for a specific term in a thesaurus. One or more terms can also be deleted.

The number of possible permutations of output text is dependant upon the number of textual input items/terms for which individual replacement databases are created along with the number of replacement items/terms included in each specific individual replacement database.

In one embodiment the input text can be rewritten by substituting one or more replacement items/terms from individual replacement databases for one or more items/terms of the input text. In one embodiment the input text can be rewritten using random items/terms selected from the individual replacement databases generated for the individual items/terms of input text. This random mechanism can be called random word spin. In such a case, a user can select a version (or versions) of the original input text that are rewritten using the random word spin. In one embodiment, one or more items/terms from the input text can be deselected for random replacement.

A word can be selected by using the mouse to click on the word. In such a case, a database builder and/or replacement database and/or the thesaurus are preferably displayed automatically on the computer display when the selected item/term is identified or selected such as by using the mouse to click on the item/term.

In one embodiment, one or more items/terms of the input text can be selected as generic input items/terms such that the original input item/term from the input text would not be used in a random selection and replacement process; and only items/terms contained in the individual replacement databases would be used.

In one embodiment, individual items/terms of the input text which are identical can have separate individual replacement databases. In one embodiment these separate individual replacement databases can have identical replacement items/terms in the same order, but be separately saved or uniquely identified. In another embodiment, these separate individual replacement databases can differ in the population of replacement items and/or in the order of listing.

In one embodiment a check can be made to ensure that identical replacement item/term are not used two or more times for a given output text. A check can also be made that the same replacement item/term is not used two or more times in an output text for the same input item/term in an input text.

In one embodiment, all of the synonyms and replacement items/terms in the individual replacement database and/or the replacement database builder and/or population of individual replacement databases, and/or population of database builders can be displayed on a computer display.

In one embodiment, pictures, music, and video can be randomly replaced in a source or seed document (e.g., input text). The present invention also includes computer software for performing the methods of the present invention.

In one embodiment the present invention also includes content generated by any of the methods of the present invention. In one embodiment the present invention also includes a web site containing this content.

In one embodiment the method allows an author of a piece of text to do several things. The user can replace words, phrases, or numbers with synonyms. For example, in the sentence, “My dog has fleas.” The word “dog” could be randomly replaced with, “canine”, “cur”, or “bitch”. The user can replace categorically analogous concepts. For example, in the sentence, “My German Shepherd has fleas.” The words “German Shepherd” could be randomly replaced with, “poodle”, “cocker spaniel”, or “wiener dog”. German Shepherd being analogous to the larger group of dogs in general. Another example could be found in the sentence, “My friend Steve is a Doctor.” The present invention can select the word “Steve” as a member of the hypothetical group, “Male First Name” (of which “Mark”, and “Jim” are also members). The process could select the word “Doctor” as a member of the group “Professions” (of which “Lawyer”, and “Dentist” are also members). Thus, a sentence could be randomly generated that says, “My friend Jim is a Dentist”, or “My friend Jim is a Doctor”, as examples.

In one embodiment the user can store synonyms, word groups, and phrase libraries to be retrieved for later use. For example, in the sentence, “My dog has fleas”, a user may add the synonym, “our” for the word “my”. The word “our” may or may not be used at the present, but it can be called up later at another instance of the word, “my”.

In one embodiment a user can create documents in text, html, xml, or other standard forms generated from the random selection of words and phrases placed upon the template of a piece of text.

In one embodiment a user can share synonym, word, and phrase libraries with other users across an intranet, or internet. When words are added to one or more databases, they can be available to all users. If the word, “red” is added to one or more databases as a synonym for “maroon”, that word can now be available to all users of the system.

In one embodiment a user can add hyperlinks to input documents for words that will link those words to such things as Amazon.Com “associate” accounts, affiliate relationships for which the correlation between the word and the relationship is apparent, or any other page desired by the user. A user could thus create a page about Real Estate, highlight the word “real estate” in the document, pre-define that the word “real estate” (when highlighted) will turn into a hyperlink to Amazon.Com through their affiliate program, and to a page at Amazon.Com with Books on “Real Estate” for sale, with the purpose of generating revenue to the user (of the randomly generated text).

In one embodiment, an input by a user is returned as unique, yet readable, understandable, and ostensibly “human-like” output. Although there exist conventional programs which take words, phrases, and numbers and deliver “random” text, no program allows a user to define how the output will be generated based on the user's individual replacement choices. This should make clear the difference between “random text” and purpose-driven article-generation. In one embodiment the present invention differs from “games” that allow for the insertion of synonyms or “word types” into otherwise static documents (e.g., “MadLibs”). In one embodiment, the present invention allows for dynamic, “on the fly” changes, alterations, and revision. So, although the method of the present invention could be used in the manner of a “Madlib” type game, the reverse is not true.

As used herein, a “synonym” may be one word or many words which are replacement words or phrases.

The present invention allows robotic revising of text and robotic randomizing of text. Such robotic revising and robotic randomizing are methods of the present invention.

The drawings constitute a part of this specification and include exemplary embodiments of the invention, which may be embodied in various forms.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a screen shot showing an input screen with input text having various terms, a thesaurus, database builder, an individual replacement database, and output text;

FIG. 2 is a screen shot showing an input screen with input text;

FIG. 3 is a screen shot showing a listing of various items from a thesaurus entry;

FIG. 4 is a screen shot showing an example of a database building screen;

FIG. 5 is a screen shot showing a listing of items/terms for an example replacement database;

FIG. 6 is a screen shot showing the saved items/terms for the replacement database of FIG. 5;

FIG. 7 is a screen shot showing a listing of the population of individual database builders with their respective items/terms; and

FIG. 8 is a flow chart showing how the method of the present invention creates a spun document by starting with a seed or source document.

### DETAILED DESCRIPTION OF THE INVENTION

One embodiment includes a method and apparatus for generating multiple related stories from a source or seed text/document which can be used for various purposes (e.g., for one or more internet web sites). In one embodiment a computer 11 can be provided having a display screen 12, a mouse 13, and internet access 14, the display screen 12 accepting one or more sets of input text 30. In one embodiment one or more output texts 110 can be generated based on a single input text 30 displayed on the display screen 12.

The input 30 can be a variable length string of ASCII text from one to an infinite number of characters. The input text string 30 can include Rich Text and/or HTML Text formats. The Rich Text and/or HTML text formats allow inclusion of hyperlinks and images to the input text object. This text can be loaded into a Rich Text or HTML text-editing window in the program and is normally, but not limited to, a composed sentence or paragraph expressing a thought or idea.

In one embodiment the outputs 110A, 110B, etc. can be one to an infinite number of alternate versions of the input text 30 that have had words and/or phrases replaced with different words and/or phrases that have nearly the same meaning. The net result is a new document that is a modification of the input 30 document that has the same meaning but has been altered by replacing one or more words and/or phrases with similar or structured replacement text. For example, this can include a simple random synonym replacement of a single term, or a more complicated structured replacement of a generic term, such as replacing the term “US City” with random cities taken from a list of US cities. Using Rich or HTML text formats; the same type of replacements can easily be done with any internet media type, including but not limited, to hyperlinks, pictures, audio and video media. This is because the HTML language allows for all of these media types to be defined with simple, easily replaced ASCII text. Any form of media can be expressed in simple text using HTML or other text based languages. Therefore, in one embodiment structured and random replacement of simple text can be performed along with replacing any form of media as well. Additionally, pictures, music and video can be randomly replaced in any document automatically with no additional special programming required. In one embodiment, an apparatus can be programmed using Visual Basic.Net object oriented code.

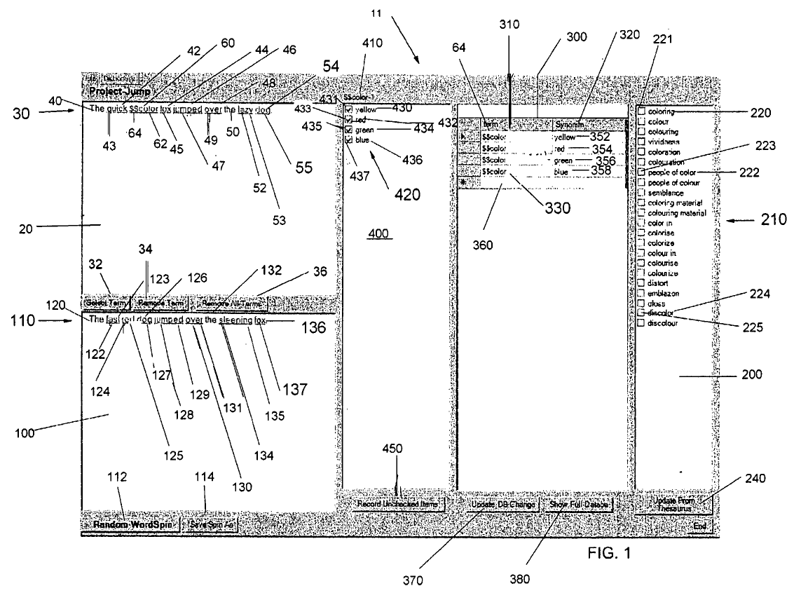

As illustrated by FIG. 1, in one embodiment computer 11 of system 10 can be provided with a population 302 of database builders (e.g., 300A, 300B, 300C, etc.), each database builder 300 having a set of replacement items/terms (e.g., 352, 354, 356, etc.), indexed to a name/title/identifier (e.g., 301A, 301B, 301C, etc.), for the respective database builder 300. In FIG. 1, only one database builder 300 is shown. In one embodiment, various items/terms (e.g., 40, 42, 44, etc.), of an input text 30 can be used to access one or more database builders 300 from the entire population 302 of database builders.

Alternatively, a single database builder 300 can be provided where replacement items/terms are indexed to individual items/terms. In one embodiment various database builders (e.g., 300A, 300B, 300C, etc.), can be used to ultimately generate one or more specific individual replacement databases (e.g., 400A, 400B, 400C), each replacement database being indexed to one or more items/terms (e.g., 42, 44, 46) of the input text. In one embodiment, the population 302 of database builders can be search by name/title/identifier 301 and/or by items/terms (e.g., 352, 354, 356) contained in each database builder (e.g., 300A, 300B, 300C). For example, some or all of the replacement items/terms (e.g., 352, 354, 356) in an individual database builder 300 can be selected by a user to populate a specific individual replacement database 400 for a specific item/term (e.g., 42) of the input text 30. Alternatively, one or more specific replacement databases (e.g., 400A, 400B, 400C) can be independently created for one or more items/terms (e.g., 42, 44, etc.), of the input text 30.

In one embodiment individual replacement database identifiers (e.g., 410A, 410B, 410C, etc.), are provided with a name/title/identifier. In one embodiment, the population of replacement databases (e.g., 400A, 400B, 400C, etc.), can be search by name/title/identifier 410 and/or by items/terms (e.g., 430, 432, 434, etc.), contained in each replacement database 400.

From this process a set 402 of specific individual replacement databases (e.g., 400A, 400B, 400C, etc.), can be created for an input text 30, each individual replacement database 400 having one or more items/terms (e.g., 430A, 432A, etc.), which can be used for replacement. From this set of specific individual replacement databases (e.g., 400A, 400B, 400C, etc.), various output permutations (e.g., 110A, 110B, 110C, etc.), of the original input text 30 can be generated wherein items from the individual replacement databases (e.g., 430,432,434,436) can be randomly selected for each of the respective input text items/terms (e.g., 42,44,46,50,54,60) thereby rewriting the input text 30 into new permutations of output text (e.g., 110A, 110B, 110C, etc.).

For example, a database builder 300 can be provided with “click” boxes that enable a user to “click” on one or more selected replacement items or terms (e.g., 352, 354, 356, 358) with a computer mouse 13, for example, when selecting a replacement synonym, when building an individual replacement database 400 for a specific term (e.g., 42) of an input text 30.

In one embodiment the computer 11 can be provided with a thesaurus 200 for including possible additional choices (e.g., 220, 222, 224, etc.), for replacement items/terms to be included in one or more database builders (e.g., 300A, 300B, etc.), in the population 302 of database builders. In one embodiment, a new database builder (e.g., 300F) can be generated from possible replacement items/terms (e.g., 220, 224) found in the thesaurus 200. In one embodiment the thesaurus 200 can be used to add to a specific individual replacement database (e.g., 400C) containing zero or more replacement items/terms (such as a list of synonyms) for any selected term of the input text (e.g., input term 48). Clicking on the button “Update From Thesaurus” 240 shown in FIG. 1 can save the individual thesaurus entries selected (by clicking on boxes such as 225) to population 302 of database builders 300 by indexing the specific term (e.g., 42) from input text 30 for which thesaurus listing 210 was created.

In one embodiment one or more replacement items/terms (e.g., 352, 354, etc.) can be entered by a user directly into a specific database builder (e.g., 300K). One or more terms can also be deleted. Additionally, one or more specific database builders (e.g., 300L, 300M) can be deleted from the population 302 of database builders.

In one embodiment one or more replacement items/terms (e.g., 430, 432) can be entered directly by a user into a specific individual replacement database (e.g., 400K). One or more terms can also be deleted. Additionally, one or more specific replacement databases (e.g., 400L, 400M) can be deleted from the population 402 of replacement databases.

In one embodiment one or more items/terms (e.g., 220, 222), can be entered directly by a user into a thesaurus database 210 for a specific term in a thesaurus 200. One or more terms can also be deleted.

The number of possible permutations of output text 110 is dependant upon the number of textual input items/terms (e.g., 42, 44, 46, etc.), for which individual replacement databases (e.g., 400A, 400B, 400C, etc.), are created along with the number of replacement items/terms (e.g., 430, 432, 434, 436, etc.), included in each specific individual replacement database 400.

In one embodiment the input text 30 can be rewritten by substituting one or more replacement items/terms (e.g., 430, 432, 434, 436, etc.), from individual replacement databases (e.g., 400A, 400B, 400C, ETC.), for one or more items/terms (e.g., 42, 44, 46, etc.), of the input text 30. In one embodiment the input text 30 can be rewritten using random items/terms selected from the individual replacement databases (e.g., 400A, 400B, 400C, ETC.), generated for the individual items/terms (e.g., 42, 44, 46, etc.) of input text 30. This mechanism can be called random word spin. In such a case, a user can select a version (or versions) of the original input text 30 that are rewritten using the random word spin. In one embodiment, one or more items/terms (e.g., 42, 44, 46) from the input text 30 can be deselected for random replacement.

A word (e.g., 42) can be selected by using the mouse 13 to click on the word. In such a case, a database builder 300 and/or replacement database 400 is preferably displayed automatically on the computer display 12 when the selected item/term (e.g., term 42) is identified (selection of term 42 indicated by reference numeral 43) by using the mouse 13 to click on the term 42.

In one embodiment, one or more items/terms (e.g., term 64) of the input text 30 can be selected as generic input items/terms such that the original input item/term (e.g., term 64) from the input text 30 would not be used in a random selection process and only items/terms (e.g., terms 352, 354, 356, 358) contained in the individual replacement databases 400 would be used. For example, in FIG. 1 term 60 of input text 30 is “color”; however, the generic indicator “$$” has been placed before “color” to indicate that term 60 will be a generic term. Accordingly, the term “color” will not be used as a replacement term for any output text 110. In the example of FIG. 1, instead, specific species of color (e.g., “yellow”; “red”; “green” and “blue”) will be used. This can be accomplished by not including selected term 60 from input text 30 in individual replacement database 400.

In one embodiment, individual items/terms of the input text which are identical (e.g., where input text 30 includes two instances of “quick”) can have separate individual replacement databases (e.g., 400C, 400K). In one embodiment these separate individual replacement databases can have identical replacement items/terms in the same order, but be separately saved or uniquely identified (e.g., 410C, 410K). In another embodiment, these separate individual replacement databases (e.g., 400C, 400K) can differ in the population of replacement items and/or in the order of listing.

In one embodiment a check can be made to ensure that the same replacement item/term is not used two times for an output text 110. A check can also be made that the same replacement item/term is not used twice in an output text 110 for the same input item/term in an input text 30.

In one embodiment, all of the synonyms and replacement items/terms in an individual replacement database (e.g., 400A) and/or the replacement database builder (e.g., 300A) can be displayed on the computer display 12.

Below specific examples will be reviewed. FIG. 1 is a screen shot showing an input screen 20 with input text 30 having various terms (e.g., 40,42, 60, 44, 46, 48, 50, and 54), a thesaurus 200, database builder 300, an individual replacement database 400, output screen 100, and output text 110. Input window 20 can accept input text 30. Preferably input window 20 can accept input text in Rich Text or an HTML format. Preferably, input window 20 includes typical word processor functions such as multiple lines, word wrapping and scroll bars to handle larger input text 30. Also preferably, a user can input items into input window 20 by either typing, cutting and pasting, or direct loading from a file.

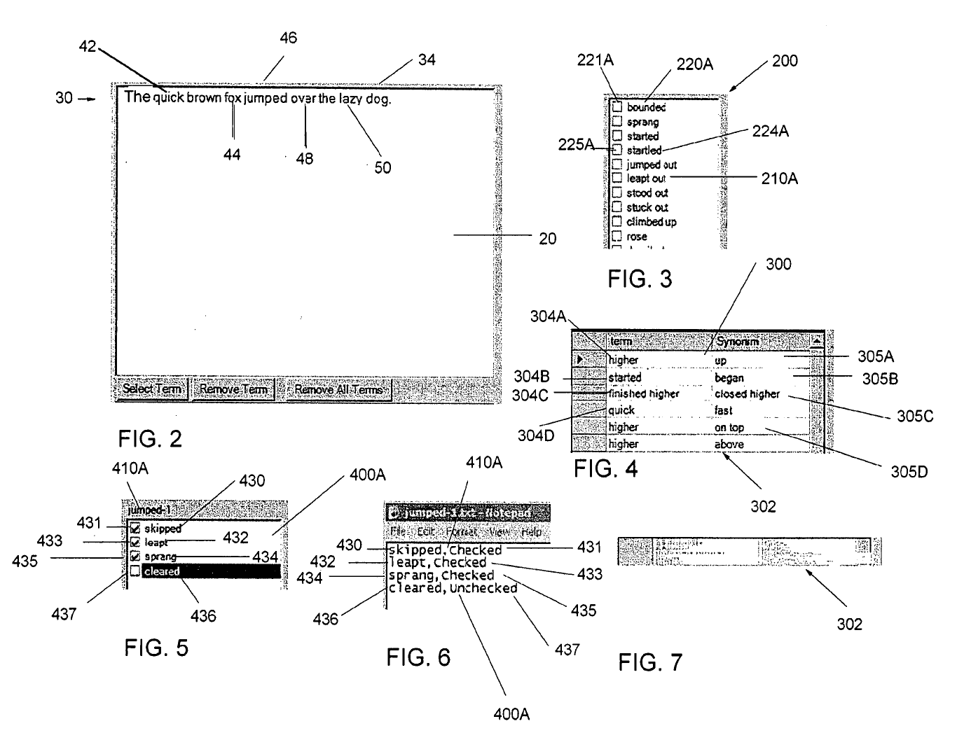

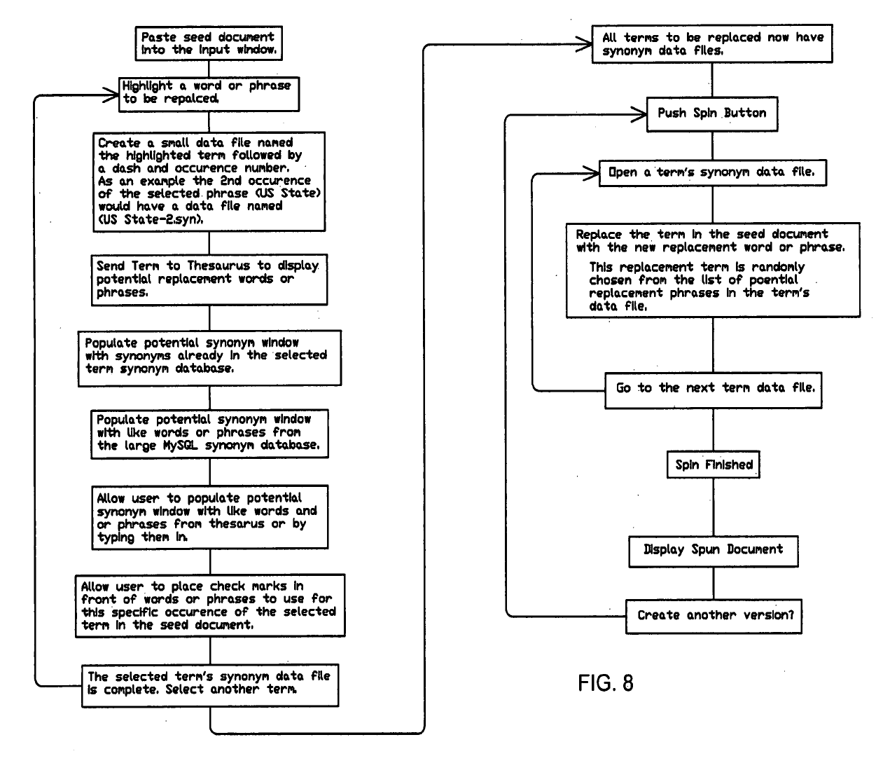

FIG. 2 is a screen shot showing input screen 20 with input text 30. For any item/term of input text 30 a replacement database 400 can be formed. The process of forming a replacement database will be described below. At this point a user can select specific items/terms from input text 30 for which replacement databases 400 will be formed. A user can double click on any item/term of input text 30 included in input screen 20, and the item/term will be highlighted. A user can also click on the “Select Term” button 32. To remove a selected term, the user can click on the “Remove Term” button 34. To remove all selected terms, the user can click on the “Remove All Terms” button.

For example, in FIG. 1, term 60 “color” has been highlighted. At this point thesaurus 200 will list possible replacement items/terms (e.g., 220, 222, 224, etc.). Additionally, database builder 300 will list possible replacement items/terms (e.g., 352, 354, etc.). Replacement database 400 will be listed which includes each item from database builder 300. The user can select one or more items/terms from thesaurus 200. Such terms will be placed in database builder 300 and listed in replacement database 400. If the user wishes to include the selected thesaurus 200 terms then he can click on the “Update DB Change” button 370 which will add the selected thesaurus terms to database builder 300. From the list of options in replacement database 400, the user can select which items/terms are to be included in replacement database 400. After checking off the selected items, the user clicks on the “Record Unchecked Items” button 450. At this point individual replacement database 400 will be saved. For example, this replacement database 400 includes a set of items/terms which can be used to replace generic term 62 of “color.”

FIG. 3 is a screen shot showing a listing 210A of various items (e.g., 220A, 222A, 224A, etc.), from a thesaurus entry 200A.

FIG. 4 is a screen shot showing an example of a population 302 of database builders (e.g., 300A, 300B, etc.), In this population 302, all database builders 300A, 300B, ETC., are stored in a single file or database and indexed by title 301. When an individual input term (e.g., 42) from input text 30 is chosen (e.g., selection indicated by 43) then each listing in population 302 matching the input term can be displayed on database builder 300. In FIG. 4 a single listing is shown having a listing of indexing terms (e.g., 304A, 304B, 304C, etc.), along with a listing of indexed terms (e.g., 305A, 305B, 305C, etc.). However, individual building databases (e.g., 300A, 300B, 300C, etc.), can be used wherein a multiple replacement items (e.g., 352, 354, 356, etc.), can be indexed to a single identifier 301 (such as “quick”) of a database builder. Although single indexing terms (e.g., 304A, etc.) are shown, “multiple phrases” can also be used. In FIG. 1, line 360 indicates a position where a user can add an individual item to a building database 300. Button “Update From Thesaurus” incorporates each checked off thesaurus term (e.g., 220, 222, 224) into building database 300. From building database 300 these same thesaurus terms can be incorporated into individual replacement database 400.

Clicking on the “Update DB Change” button saves changes to individual database builders (e.g., 300A, 300B) which are included in the population 302 of database builders. Clicking on “Show Full Databa” button 380 provides a listing similar to that shown in FIG. 7 which includes a list of all database builders (e.g., 300A, 300B, etc.), included in population 302. FIG. 7 is a screen shot showing a listing of the population of individual database builders with their respective items/terms.

FIG. 5 is a screen shot showing a listing of possible items/terms (e.g., 430, 432, 434, 436) for an example replacement database (e.g., 400A). For example, this particular listing could be generated by double clicking on “jumped” 46 of input text 30 placed in input window 20. Double clicking can automatically populate individual replacement database 400A with every term in population 302 of database builders 300 indexed to “jumped.” Each possible replacement term (e.g., 430, etc.) is provided with a check box (e.g., 431, etc.), so that a decision can be made regarding which of the possible terms will be included in replacement database 400A. FIG. 6 is a screen shot showing the saved items/terms (e.g., 430, 432, etc.), for the replacement database 400A of FIG. 5. In this database each of the possible terms are listed with a identifier of being either “checked” or “unchecked.” In this example, “checked” indicates that the specific terms will be used as part of replacement database 400A. “Unchecked” indicates that the term will not be used as part of replacement database 400A. A unique name 410A can be given to the file holding the information related to replacement database 400A.

The process shown in FIGS. 5 and 6 can be repeated for each item/term in input text 30 creating individual replacement databases (e.g., 400B, 400C, 400D, etc.). Unique names (e.g., 410B, 410C, 410D, etc.), can be given to the respective files holding the information related to replacement databases (e.g., 400B, 400C, 400D, ETC.). To assist in tracking individual replacement databases to the items/terms being replaced, the following terminology is preferred. Each database is named by the term being replaced from the input text followed by a sequential integer number. The Example shown is “jumped” followed by a “1.” If a second “jumped” is found in input text 30, then “jumped” followed by a “2” will be used for the replacement database 400 for the second occurrence of “jumped.”. Similarly, a third name can be followed by a “3” and so on. Similarly, the first replacement database for the term “quick” will be named “quick” followed by a “1.” Where a second occurrence of quick is seen the next replacement database can be named “quick” followed by a “2.” In this manner the individual replacement databases can be easily identified, tracked, and modified if needed. Operating the “Record Unchecked Items” button in FIG. 1 can save an individual replacement database 400A.

To create various iterations of output text (e.g., 110A, 110B, 110C, ETC.), the user can click on the “Random WordSpin” button 112. At this point the system 10 will go through a loop replacing each selected item/term (e.g., 42, 60, 44, 46, 48, and 54 in FIG. 1) with a random item/term from the individual replacement databases (e.g., 400A, 400B, etc.). The user can save any particular output text (e.g., 110B) by clicking on the “Save Spin As” button 114. In a preferred embodiment, the user can also edit any particular generated output text (e.g., 110C) after it has been created and/or saved.

In one embodiment, a one step process can be used to generate one or more outputs (e.g., 110A, 110B, ETC.) from an input text 30. In this embodiment, the input text 30 can be placed in input window 20 and system 10 can be asked to create one or more output texts 110. To perform this task, the system 10 can break input text 30 into one or more items to be replaced (e.g., terms 42,60,44,46,48,52,54). Then system 10 can use database builder 300 to create specific replacement databases (e.g., 400A, 400B, 400C, etc.) for the terms to be replaced. The specific replacement databases can include each replacement item in database builder 300 indexed to a match for a specific item of input text (e.g., item 42). At this point various permutations of input text can be created by substituting replacement items for each of the input items. In an alternative embodiment, matching items in thesaurus 200 can be used to populate the individual replacement databases. It is preferred that a check is made to ensure no duplications of items in the individual replacement databases. One or more output texts can be randomly generated through this process without requiring individual selection by the user. In an alternative embodiment, specific input words which can be automatically removed from the replacement process (such as “and”; “but”; “or”; “the”; “a”). Additionally, where no replacement items are found for a specific input item (in the database builder), no replacement will be performed for that input item. Alternatively, a message can be displayed the user given an option to enter one or more replacement items.

Below are included specific examples of input text 30 and generated output text 110.

### EXAMPLE 1

The method of the present invention can be used to “write” unique daily stock commentary on every stock traded on the major US and Canadian exchanges, such as in the following example.

This example of the generated text can be seen at this link: http://www.eeproductcenter.com/showPressRelease.jhtml?articleID=85834, also reproduced in the following paragraph:

Stock Market Ratings by StockPickReport.com for Applied Materials, Texas Instruments, Eli Lilly, Merrill Lynch, Sina.Com BizWire

(Jul. 3, 2003 10:31 AM ET)

Business Editors
SHREVEPORT, La.—(BUSINESS WIRE)—Jul. 3, 2003—StockPickReport.Com (IARD#119079—http://www.stockpickreport.com/?src=bw) makes these short-term stock recommendations:

Applied Materials (NASDAQ:AMAT)—BUY—http://pr.stockpickreport.com/AMAT.htm

Texas Instruments (NYSE:TXN)—BUY—http://pr.stockpickreport.com/TXN.htm

Eli Lilly (NYSE:LLY)—BUY—http://pr.stockpickreport.com/LLY.htm

Merrill Lynch (NYSE:MER)—BUY—http://pr.stockpickreport.com/MER.htm

Sina.Com (NASDAQ:SINA)—WEAK BUY—http://pr.stockpickreport.com/SINA.htm

Applied Materials (NASDAQ:AMAT) StockPickReport.Com Rating: BUY http://pr.stockpickreport.com/AMAT.htm

Applied Materials develops, manufactures, markets and services semiconductor wafers fabrication equipment and related spare parts for the semiconductor industry.

The short-term trend seems to be higher for the stock's daily volume. In addition, based on short-term stochastics, we believe the stock will be moving higher. Subsequently, the trend was to higher levels for AMAT recently. Our research indicates probable upside for AMAT from current prices. AMAT could see gains from here but those gains may not be striking on a percent basis compared to a stock with a Strong Buy rating.

For clarification on how we rate AMAT a BUY, please visit:http://pr.stockpickreport.com/AMAT.htm.

Texas Instruments (NYSE:TXN) StockPickReport.Com Rating: BUY http://pr.stockpickreport.com/TXN.htm

Texas Instruments manufactures products used in the commercial electronic and electric equipment industries. The price action has been to higher levels for the stock lately. Furthermore, based on short-term stochastics, we believe the stock will be moving higher. In conclusion, the near-term direction looks to be on the way down in regards to TXN's volume. Our research indicates probable upside for TXN from current prices. TXN could see gains from here but those gains may not be striking on a percent basis compared to a stock with a Strong Buy rating.

For clarification on how we rate TXN a BUY, please visit: http://pr.stockpickreport.com/TXN.htm.

Eli Lilly (NYSE:LLY) StockPickReport.Com Rating: BUY http://pr.stockpickreport.com/LLY.htm

The group's principal activities are to discover, develop, manufacture and market pharmaceutical-based health care solutions. the pharmaceutical products include: neuroscience, endocrine, anti- infective, cardiovascular agents, oncology and animal health. Based on short-term stochastics, we believe the stock will be moving higher. Next, LLY investors might want to note that the stock's end-of-day price moved up over the last 5 day period. In conclusion, the near-term trend for the stock's share volume looks to be on the way up. Our research indicates probable upside for LLY from current prices. LLY could see gains from here but those gains may not be striking on a percent basis compared to a stock with a Strong Buy rating.

For clarification on how we rate LLY a BUY, please visit: http://pr.stockpickreport.com/LLY.htm.

Merrill Lynch (NYSE:MER) StockPickReport.Com Rating: BUY http://pr.stockpickreport.com/MER.htm

Merrill Lynch provides investment, financing, advisory, insurance and related products and services on a global basis. Based on short-term stochastics, we believe the stock will be moving higher. Furthermore, the stock's price headed to higher ground over the last week or so. In conclusion, the stock's volume looks like it's on the way up. Our research indicates probable upside for MER from current prices. MER could see gains from here but those gains may not be striking on a percent basis compared to a stock with a Strong Buy rating.

For clarification on how we rate MER a BUY, please visit: http://pr.stockpickreport.com/MER.htm.

Sina.Com (NASDAQ:SINA) StockPickReport.Com Rating: WEAK BUY http://pr.stockpickreport.com/SINA.htm

SINA Corporation, formerly known as SINA.com, is an online media company and value-added information service provider for China and the global Chinese communities. Technical reading of SINA's most up-to-date near-term oscillating stochastic number leads our analysts to hold the opinion that SINA's price should reverse direction soon. In addition, the general direction was higher for SINA in the last week or so. Subsequently, the short-term trend looks to be higher for the stock's daily volume. Our research indicates possible upside from current prices for SINA. However, we do not advise the initiation of new long positions at these prices. Profit-taking may be ahead for SINA.

For clarification on how we rate SINA a WEAK BUY, please visit: http://pr.stockpickreport.com/SINA.htm.

What These Ratings Mean:

StockPickReport.Com ranks stocks with a proprietary unbiased system of technical analysis. These ratings do not indicate a “long term” view of any company listed. These are ratings that reflect our opinion of a stock's potential price movement over the next five to ten trading sessions. The stock ratings range from +10 (which indicates our view that a stock has a great chance to move higher) to −10 (which indicates our belief that a stock has a great chance to move lower). These ratings may change based on daily market conditions.

About StockPickReport.com:

StockPickReport.Com is a stock research firm. Our daily commentary has regular, worldwide distribution. We are Registered Investment Advisors. We do not accept third-party compensation to make stock suggestions. We do not own shares of any stock we rate. Investors are advised that this analysis is issued solely for informational purposes and is not to be construed as an offer to sell or the solicitation of an offer to buy. This report does not have regard to the specific investment objectives, financial situation and the particular needs of any specific person who may receive this information. The information contained herein is based on sources that we believe to be reliable but is not guaranteed by us as being accurate and does not purport to be a complete statement or summary of the available data. Past performance is no guarantee of future results. Any opinions expressed herein are statements of our judgment as of the date of publication and are subject to change without notice. Reproduction without written permission is prohibited.

StockPickReport.Com's goal is to provide stock research FREE from bias or conflicts. You can get your FREE trial to StockPickReport.Com at http://www.stockpickreport.com/?src=bw--30--KH/na* CONTACT: StockPickReport.Com, Shreveport Dewey Burchett, 318/219-2368 info@stockpickreport.com http://www.stockpickreport.com/index.htm KEYWORD: LOUISIANA INDUSTRY

KEYWORD: TELECOMMUNICATIONS HARDWARE COMPUTERS/ELECTRONICS BANKING PHARMACEUTICAL INVESTMENT OPINION SOURCE: StockPickReport.Com

### EXAMPLE 2

The following example 2 provides original text at this link: http://www.duderockstar.com/reviews/donmadisonintro.htm, also reproduced in the following paragraph:
Madison is a time machine to the time of “skull crushing” guitar music. You may recall that every metal string-meister once wielded a Charvel. Yup, what a special time! Also, who could dismiss the fact that the toughest axe-slingers had paintings of cute characters depicted on their axe? Provided that you are partial to Megadeth you will admire the hard rock of Don Madison. Click Here to Read the Review!
   Here are Links to Generated Content:

http://www.duderockstar.com/reviews/donmadisonintro2.htm, also reproduced in the following paragraph:
Don Madison is a time machine to the days of “smack down” metal guitar. You might be able to recall how each metal guitar player once wielded a Jackson. Yup, those were the days! And, who could dismiss how all the heaviest fret jockeys decided to get cartoons of cuddly characters painted on their electric guitar? If you like Megadeth you will fall in love with the sound of Don Madison. Click Here to Read the Review!

http://www.duderockstar.com/reviews/donmadisonintro3.htm, also reproduced in the following paragraph:
Mr. Madison is a throwback to the good old days of “skull crushing” metal guitar. You may recall how each metal gunslinger once played a Jackson. Yep, those were the days! Also, who is going to overlook how the toughest guitar players had cartoons of cuddly characters drawn on their axe? Provided that you are partial to Pantera you should really go for the heavy metal style of Don Madison. Click Here to Read the Review!

http://www.duderockstar.com/reviews/donmadisonintro4.htm, also reproduced in the following paragraph:
Madison's sound is a timewarp to the glory days of “riff oriented” guitar playing. Listeners should remember that every hard rock string-meister more often than not played a Charvel. Wow, that was a great time to be alive! Then, who is going to forget the fact that the loudest guitar players decided to get drawings of cute creatures air-brushed on their guitar? If you have a sweet spot for Chris Poland you should really go for the hard rock of Don Madison. Click Here to Read the Review!

http://www.duderockstar.com/reviews/donmadisonintro5.htm, also reproduced in the following paragraph:
Mr. Madison's heavy metal style is a timewarp to all the halcyon days of “riff oriented” guitar heroes. Music fans should recall how each hard rock axe-slinger generally wielded a Charvel. You know, those were the days! Also, who is going to dismiss how the nastiest gunslingers wanted drawings of cutesy animals drawn on their guitar? If you enjoy Slayer you should fall in love with the hard rock of Don Madison. Click Here to Read the Review!

http://www.duderockstar.com/reviews/donmadisonintro6.htm, also reproduced in the following paragraph:
Madison's hard rock is a timewarp to the time of “heavier than metal” guitar. Listeners should recall how every head-banging guitar player generally stroked a Kramer. Yeah, that was a great time to be alive! Plus, who is going to overlook the fact that all the loudest fret-jockeys wanted cartoons of cute characters drawn on their guitar? If you love Pantera you should go nuts over the music of Don Madison. Click Here to Read the Review!

All measurements disclosed herein are at standard temperature and pressure, at sea level on Earth, unless indicated otherwise.

The following is a list of reference numerals:

LIST FOR REFERENCE NUMERALS

| (Part No.) | (Description) |
|---|---|
| 10 | system |
| 11 | computer |
| 12 | display screen |
| 13 | mouse |
| 14 | internet access |
| 20 | input window |
| 30 | input text |
| 32 | select button |
| 34 | remove button |
| 36 | remove all button |
| 40 | item of input text |
| 41 | indicator of selection |
| 42 | item of input text |
| 43 | indicator of selection |
| 44 | item of input text |
| 45 | indicator of selection |
| 46 | item of input text |
| 47 | indicator of selection |
| 48 | item of input text |
| 49 | indicator of selection |
| 50 | item of input text |
| 51 | indicator of input text |
| 52 | item of input text |
| 53 | indicator of input text |
| 54 | item of input |
| 55 | indicator of input text |
| 60 | generic item of input text |
| 62 | indicator of selection |
| 64 | generic indicator (or one time usage) |
| 70 | replace without using input item |
| 100 | output window |
| 110 | output text |
| 112 | generate |
| 114 | save |
| 116 | random |
| 117 | non-random |
| 120 | item of output text |
| 121 | indicator of selection |
| 122 | item of output text |
| 123 | indicator of selection |
| 124 | item of output text |
| 125 | indicator of selection |
| 126 | item of output text |
| 127 | indicator of selection |
| 128 | item of output text |
| 129 | indicator of selection |
| 130 | item of output text |
| 131 | indicator of selection |
| 132 | item of output text |
| 133 | indicator of selection |
| 134 | item of output text |
| 135 | indicator of selection |
| 136 | item of output text |
| 137 | indicator of selection |
| 200 | thesaurus |
| 210 | general category or database |
| 220 | item |
| 221 | indicator of selection |
| 222 | item |
| 223 | indicator of selection |
| 224 | item |
| 225 | indicator of selection |
| 226 | item |
| 227 | indicator of selection |
| 228 | item |
| 240 | update |
| 300 | database builder |
| 301 | name/title/identifier |
| 302 | population of database builders |
| 304 | indexing term |
| 305 | replacement terms |
| 310 | term column |
| 320 | replacement column |
| 330 | input row |
| 352 | item |
| 354 | item |
| 356 | item |
| 358 | item |
| 360 | entering additional item |
| 370 | update |
| 380 | show full replacement database |
| 400 | individual replacement database |
| 402 | set of replacement database |
| 410 | name/title/identifier |
| 420 | replacement population |
| 430 | item |
| 431 | indication of selection |
| 432 | item |
| 433 | indication of selection |
| 434 | item |
| 435 | indication of selection |
| 436 | item |
| 437 | indication of selection |
| 450 | record |

The foregoing embodiments are presented by way of example only; the scope of the present invention is to be limited only by the following claims.

1. A method of generating multiple related stories for an internet web site or web sites, comprising the steps of:
a) providing a computer having a display screen, a mouse, and internet access;
b) generating a story to provide an input text that is displayed on the display screen;
c) providing the computer with a thesaurus for locating synonyms for terms of the input text to be replaced;
d) using the thesaurus to populate a check list with synonyms for a selected term of the input text;
e) selecting some or all of the synonyms of step “d” to populate a personal database of chosen replacement terms;
f) rewriting the input text of step “b” by substituting one or more terms from the personal database of step “e” for a selected term of the story, wherein rewriting includes using the computer to supply one or more synonyms of step “e” as a substitute word for the selected word.

2. The method of claim 1 wherein the check list generated in step “a” is provided with click boxes that enable a user to click on a selected synonym with a computer mouse when selecting the synonym in step “e”.

3. The method of claim 1 wherein in step “d” one or more synonyms are entered directly in the database by a user.

4. The method of claim 1 wherein in step “f” only some of the synonyms in the personal data base are supplied as synonym(s).

5. The method of claim 1 wherein the input text is rewritten with random term selected by a random word spin.

6. The method of claim 1 wherein in step “f” a word is selected by using the mouse to click on the word.

7. The method of claim 6 wherein the personal database is displayed automatically on the computer display when the selected term is identified by using the mouse to click on the term.

8. The method of claim 1 wherein all of the synonyms and replacement terms in the personal database can be displayed on the computer display.

9. The method of claim 5 wherein a user can select a version or versions of the original input text that are rewritten using the random word spin.

10. The method of claim 1 wherein pictures, music, and video can be randomly replaced in any story of step “a”.

11. A method of generating multiple related stories, comprising the steps of:
a) providing a computer having a display screen;
b) providing an input story having a plurality of input items displayed on the display screen;
c) providing the computer with at least one database builder, the database builder including a population of items which can be selected by a user as replacement choices;
d) from the input story of step “b”, selecting at least one of the input items for replacement;
e) from the database builder of step “c”, selecting a first group of items from the database builder which can be used as replacement choices; and
f) rewriting the input story of step “b” by substituting for the selected at least one input item in step “d” with one or more items from the first group of items selected in step “e” as replacement choices.

12. The method of claim 11, further comprising the steps of selecting from the input story of step “b” a plurality of input items for replacement, and selecting from the database builder of step “e” respectively selecting a plurality of groups of items which can be used as replacement choices respectively for various input items for replacement.

13. The method of claim 12, further comprising the step of providing a thesaurus for locating synonyms of one or more input items selected for replacement selected in step “d.”

14. The method of claim 13, wherein for at least one input item selected for replacement the thesaurus provides a list of possible synonyms and at least one synonym is selected for replacement.

15. The method of claim 14, wherein each synonym selected is added to the database builder population.

16. The method of claim 14, further comprising the step of choosing whether one or more selected synonyms are added to the database builder population.

17. The method of claim 11, further comprising the step of entering at least one item to the population provided in step “c”.

18. The method of claim 11, further comprising the step of entering at least one additional item beyond to the group of items selected in step “e”.

19. The method of claim 11, wherein the first group of items selected in step “e” includes the at least one input item selected in step “d.”

20. The method of claim 11, wherein the first group of items selected in step “e” omits the at least one input item selected in step “d.”

21. The method of claim 20, wherein a generic indicator is added to the at least one input item selected in step “d” to indicate that omission should occur.

22. The method of claim 21, wherein the generic indicator is a symbol.

23. The method of claim 11, wherein the database builder of step “c” is provided with click boxes that enable a user to click on one or more selected items with a computer mouse when selecting the first group of items in step “e”.

24. The method of claim 11, wherein in step “e” only some of the population of items from step “c” are selected as replacement choices.

25. The method of claim 11, wherein in step “f” the input story is rewritten with a random selection of the replacement choices from step “e.”

26. The method of claim 11, wherein in step “e” a replacement choice selected by using the mouse to click on the replacement choice.

27. The method of claim 11, wherein the at least one database builder is displayed automatically on the computer display when the selected at least one input item is identified by using a mouse to click on the selected at least one input item.

28. The method of claim 11, wherein all of the population of items from the database builder can be displayed on the computer display.

29. The method of claim 11, comprising the further step of using at least one of the versions of the rewritten story from step “f” as a new input story in step “b”.

30. The method of claim 11 wherein at least one database builder in step “c” includes pictures, music, or video in its population of items for replacement choices.

31. Computer software for performing the method of any prior claim.

32. Content generated by any of claims 1-30.

33. A web site containing the content of claim 32.

34. The invention(s) substantially as shown and/or described herein.
